(19) United States
(12) Patent Application Publication
(10) Pub. No.: US 2023/0006356 A1
(43) Pub. Date: Jan. 5, 2023

(54) ANTENNA DEVICE AND DISPLAY DEVICE INCLUDING THE SAME

(71) Applicants: DONGWOO FINE-CHEM CO., LTD., Jeollabuk-do (KR); POSTECH RESEARCH AND BUSINESS DEVELOPMENT FOUNDATION, Gyeongsangbuk-do (KR)

(72) Inventors: Ho Dong YOON, Gyeonggido (KR); Dong Pil PARK, Incheon (KR); Byung Jin CHOI, Incheon (KR); Won Bin HONG, Seoul (KR); Jun Ho PARK, Gyeongsangbuk-do (KR)

(21) Appl. No.: 17/943,298

(22) Filed: Sep. 13, 2022

Related U.S. Application Data
(63) Continuation of application No. PCT/KR2021/001941, filed on Feb. 16, 2021.

(30) Foreign Application Priority Data
Mar. 13, 2020 (KR) 10-2020-0031166
Mar. 13, 2020 (KR) 10-2020-0031167

(51) Int. Cl. H01Q 13/20; H01Q 21/06; H01Q 9/06; H01Q 9/04

(52) U.S. Cl. CPC H01Q 13/206; H01Q 21/065; H01Q 9/065; H01Q 9/0414

(57) ABSTRACT

An antenna device according to an embodiment includes an array antenna including a plurality of antenna elements, a first flexible printed circuit board (FPCB) including a plurality of first transmission lines which are electrically connected to the plurality of antenna elements and have different lengths, and a radio frequency integrated circuit (RFIC) electrically connected to the plurality of first transmission lines.

### CROSS-REFERENCE TO RELATED APPLICATION AND CLAIM OF PRIORITY

The present application is a continuation of application to International Application No. PCT/KR2021/001941 with an International Filing Date of Feb. 16, 2021, which claims the benefit of Korean Patent Application Nos. 10-2020-0031166 filed on Mar. 13, 2020 and 10-2020-0031167 filed on Mar. 13, 2020 at the Korean Intellectual Property Office, the disclosures of which are incorporated by reference herein in their entirety.

### BACKGROUND

### 1. Field of the Invention

The present invention relates to an antenna device and a display device including the same.

### 2. Description of the Related Art

Recently, according to development of the information-oriented society, wireless communication techniques such as Wi-Fi, Bluetooth, and the like are implemented, for example, in a form of smartphones by combining with display devices. In this case, an antenna may be coupled to the display device to perform a communication function.

Recently, with mobile communication techniques becoming more advanced, it is necessary for an antenna for performing communication in ultra-high frequency bands to be coupled to the display device.

In addition, as the display device on which the antenna is mounted becomes thinner and lighter, a space occupied by the antenna may also be reduced. Accordingly, it is not easy to simultaneously implement the transmission and reception of high frequency and wideband signals within a limited space.

For example, in the case of recent 5G mobile communication in high frequency bands, as the wavelength is shorter, a case in which signal transmission and reception may be blocked occurs, and it may be necessary to implement the transmission and reception of multi-band signals.

Therefore, it is necessary to apply an antenna to a display device in a form of a film or a patch, and in order to implement the above-described high frequency communication, a structural design of the antenna to secure the reliability of radiation characteristics is required despite a thin structure.

For example, Korean Patent Laid-Open Publication No. 2010-0114091 discloses a dual patch antenna module, but it may not be sufficient to be applied to a small device because the antenna module is manufactured in a thin shape within a limited space.

### SUMMARY

It is an object of the present invention to provide an antenna device and a display device including the same.

The above object of the present invention will be achieved by one or more of the following features or constructions:

1. An antenna device including: an array antenna including a plurality of antenna elements; a first flexible printed circuit board (FPCB) including a plurality of first transmission lines which are electrically connected to the plurality of antenna elements and have different lengths; and a radio frequency integrated circuit (RFIC) electrically connected to the plurality of first transmission lines.

2. The antenna device according to the above 1, wherein the RFIC is configured to adjust at least one of a phase and a magnitude of an electric signal applied to each first transmission line in order to compensate for at least one of a phase delay and a loss generated in each first transmission line.

3. The antenna device according to the above 1, wherein the RFIC is mounted on the first FPCB.

4. The antenna device according to the above 1, further including a printed circuit board (PCB) electrically connected to the first FPCB, wherein the RFIC is mounted on the PCB.

5. The antenna device according to the above 1, wherein each of the plurality of antenna elements includes: a dielectric layer; a radiator disposed on an upper surface of the dielectric layer; and a second transmission line connected to the radiator on the upper surface of the dielectric layer.

6. The antenna device according to the above 5, wherein the array antenna includes: a first array antenna including a plurality of first antenna elements arranged in a first direction; and a second array antenna including a plurality of second antenna elements arranged in a second direction.

7. The antenna device according to the above 6, wherein a beamforming direction of the first array antenna is adjusted on a yz plane, and a beamforming direction of the second array antenna is adjusted on an xz plane.

8. The antenna device according to the above 6, wherein the first direction and the second direction are perpendicular to each other.

9. The antenna device according to the above 5, wherein second transmission lines of at least some of the plurality of antenna elements have different lengths.

10. The antenna device according to the above 5, wherein the radiator and the second transmission line are formed in a mesh structure, respectively.

11. The antenna device according to the above 5, wherein each of the plurality of antenna elements further includes a ground layer disposed on a lower surface of the dielectric layer.

12. The antenna device according to the above 5, wherein each of the plurality of antenna elements further includes a dummy pattern disposed around the radiator and the second transmission line on the upper surface of the dielectric layer.

13. The antenna device according to the above 1, wherein each of the plurality of antenna elements is a series-fed array antenna element.

14. The antenna device according to the above 13, wherein each of the plurality of antenna elements includes: a dielectric layer; a plurality of radiators arranged on an upper surface of the dielectric layer; and a plurality of second transmission lines configured to connect the plurality of radiators in series on the upper surface of the dielectric layer.

15. The antenna device according to the above 13, wherein the plurality of antenna elements are arranged in a first direction, and the radiators are arranged in a second direction.

16. The antenna device according to the above 15, wherein the first direction and the second direction are perpendicular to each other.

17. The antenna device according to the above 15, further including: a plurality of third transmission lines configured to cross-connect the plurality of radiators of the plurality of antenna elements in two dimensions to form a matrix structure.

18. The antenna device according to the above 17, wherein a beamforming direction of a first direction arrangement of the plurality of radiators is adjusted on a yz plane, and a beamforming direction of a second direction arrangement of the plurality of radiators is adjusted on an xz plane.

19. The antenna device according to the above 17, further including a second FPCB which is electrically connected with at least some of the plurality of third transmission lines and includes a plurality of fourth transmission lines having different lengths.

20. The antenna device according to the above 19, wherein the RFIC is configured to adjust at least one of a phase and a magnitude of an electric signal applied to each fourth transmission line in order to compensate for at least one of a phase delay and a loss generated in each fourth transmission line.

21. A display device including the antenna device according to the above-described embodiments.

By forming the transmission lines of the FPCB connected to each antenna element to have different lengths, it is possible to implement transmission lines each of which has a minimum physical length, such that a loss due to the transmission lines may be reduced.

In addition, by adjusting the phase and magnitude of electric signals applied to the transmission lines of the FPCB connected to each antenna element, it is possible to compensate for a phase delay and a loss of each transmission line.

Further, by forming a plurality of array antennas arranged in different directions, it is possible to efficiently operate the antenna device, and implement an antenna device having various functions.

Furthermore, by forming at least a part of each antenna element in the antenna pattern layer in a mesh structure, a transmittance of the antenna element may be improved, and it is possible to suppress the antenna element from being viewed by a user when mounting it on the display device.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a schematic cross-sectional view illustrating an antenna element according to an exemplary embodiment;

FIG. 2 is a schematic plan view illustrating an antenna element according to an exemplary embodiment;

FIGS. 3 to 6 are views illustrating antenna devices according to exemplary embodiments;

FIG. 7 is a schematic plan view illustrating an antenna element according to an exemplary embodiment;

FIGS. 8 to 11 are views illustrating antenna devices according to exemplary embodiments; and

FIG. 12 is a schematic plan view for describing a display device according to an exemplary embodiment.

### DETAILED DESCRIPTION OF THE EMBODIMENTS

Hereinafter, embodiments will be described in detail with reference to the accompanying drawings. In denoting reference numerals to components of respective drawings, it should be noted that the same components will be denoted by the same reference numerals although they are illustrated in different drawings.

In description of preferred embodiments of the present invention, the publicly known functions and configurations that are judged to be able to make the purport of the present invention unnecessarily obscure will not be described in detail. Further, wordings to be described below are defined in consideration of the functions of the embodiments, and may differ depending on the intentions of a user or an operator or custom. Accordingly, such wordings should be defined on the basis of the contents of the overall specification.

It will be understood that, although the terms first, second, etc. may be used herein to describe various elements or components, these elements or components should not be limited by these terms. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, components and/or a combination thereof, but do not preclude the presence or addition of one or more other features, integers, steps, operations, elements, components, and/or a combination thereof.

Further, directional terms such as “one side,” “the other side,” “upper,” “lower,” and the like are used in connection with the orientation of the disclosed drawings. Since the elements or components of the embodiments of the present invention may be located in various orientations, the directional terms are used for illustrative purposes, and are not intended to limit the present invention thereto.

In addition, a division of the configuration units in the present disclosure is intended for ease of description and divided only by the main function set for each configuration unit. For example, two or more of the configuration units to be described hereinafter may be combined into a single configuration unit or formed by two or more of divisions by function into more than a single configuration unit. Further, each of the configuration units to be described hereinafter may additionally perform a part or all the functions among functions set for other configuration units other than being responsible for the main function, and a part of the functions among the main functions set for each of the configuration units may be exclusively taken and certainly performed by other configuration units

An antenna element described in the present disclosure may be a patch antenna or a microstrip antenna manufactured in a form of a transparent film. For example, the antenna element may be applied to electronic devices for high frequency or ultra-high frequency (e.g., 3G, 4G, 5G or more) mobile communication, Wi-Fi, Bluetooth, near field communication (NFC), global positioning system (GPS), and the like, but it is not limited thereto. Herein, the electronic device may include a mobile phone, a smart phone, a tablet, a laptop computer, a personal digital assistant (PDA), a portable multimedia player (PMP), a navigation device, an MP3 player, a digital camera, a wearable device and the like. The wearable device may include a wristwatch type, a wrist band type, a ring type, a belt type, a necklace type, an ankle band type, a thigh band type, a forearm band type wearable device or the like. However, the electronic device is not limited to the above-described example, and the wearable device is also not limited to the above-described example. In addition, the antenna element may be applied to various target structures such as an automobile, a building and the like.

In the following drawings, two directions which are parallel to an upper surface of a dielectric layer and cross each other perpendicularly are defined as an x direction and a y direction, and a direction perpendicular to the upper surface of the dielectric layer is defined as a z direction. For example, the x direction may correspond to a width direction of the antenna element, the y direction may correspond to a length direction of the antenna element, and the z direction may correspond to a thickness direction of the antenna element.

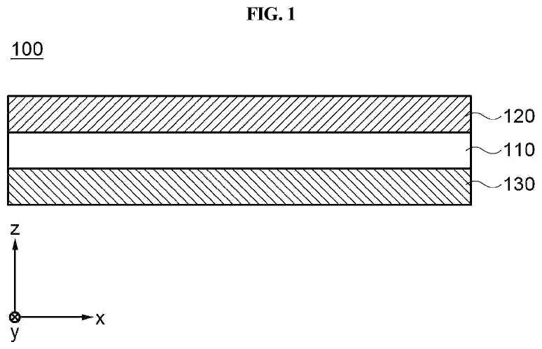

FIG. 1 is a schematic cross-sectional view illustrating an antenna element according to an exemplary embodiment.

Referring to FIG. 1, an antenna element 100 may include a dielectric layer 110 and an antenna pattern layer 120.

The dielectric layer 110 may include an insulation material having a predetermined dielectric constant. According to an embodiment, the dielectric layer 110 may include an inorganic insulation material such as glass, silicon oxide, silicon nitride, or metal oxide, or an organic insulation material such as an epoxy resin, an acrylic resin, or an imide resin. The dielectric layer 110 may function as a film substrate of the antenna element on which an antenna pattern layer 120 is formed.

According to an embodiment, a transparent film may be provided as the dielectric layer 110. In this case, the transparent film may include a polyester resin such as polyethylene terephthalate, polyethylene isophthalate, polyethylene naphthalate, polybutylene terephthalate, etc.; a cellulose resin such as diacetyl cellulose, triacetyl cellulose, etc.; a polycarbonate resin; an acryl resin such as polymethyl (meth)acrylate, polyethyl (meth)acrylate, etc.; a styrene resin such as polystyrene, acrylonitrile-styrene copolymer, etc.; a polyolefm resin such as polyethylene, polypropylene, cyclic polyolefin or polyolefin having a norbornene structure, ethylene-propylene copolymer, etc.; a vinyl chloride resin; an amide resin such as nylon, aromatic polyamide; an imide resin; a polyether sulfonic resin; a sulfonic resin; a polyether ether ketone resin; a polyphenylene sulfide resin; a vinylalcohol resin; a vinylidene chloride resin; a vinylbutyral resin; an allylate resin; a polyoxymethylene resin; a thermoplastic resin such as an epoxy resin and the like. These compounds may be used alone or in combination of two or more thereof. In addition, a transparent film made of a thermosetting resin or an ultraviolet curable resin such as (meth)acrylate, urethane, acrylic urethane, epoxy, silicone, and the like may be used as the dielectric layer 110.

According to an embodiment, an adhesive film such as an optically clear adhesive (OCA), an optically clear resin (OCR), and the like may also be included in the dielectric layer 110.

According to an embodiment, the dielectric layer 110 may be formed in a substantial single layer, or may be formed in a multilayer structure of two or more layers.

Capacitance or inductance may be generated by the dielectric layer 110, thus to adjust a frequency band which can be driven or sensed by the antenna element 100. When the dielectric constant of the dielectric layer 110 exceeds about 12, a driving frequency is excessively reduced, such that driving of the antenna in a desired high frequency band may not be implemented. Therefore, according to an embodiment, the dielectric constant of the dielectric layer 110 may be adjusted in a range of about 1.5 to 12, and preferably about 2 to 12.

According to an embodiment, an insulation layer (e.g., an encapsulation layer, a passivation layer, etc. of a display panel) inside the display device on which the antenna element 100 is mounted may be provided as the dielectric layer 110.

The antenna pattern layer 120 may be disposed on the upper surface of the dielectric layer 110.

The antenna pattern layer 120 may include a low resistance metal such as silver (Ag), gold (Au), copper (Cu), aluminum (Al), platinum (Pt), palladium (Pd), chromium (Cr), titanium (Ti), tungsten (W), niobium (Nb), tantalum (Ta), vanadium (V), iron (Fe), manganese (Mn), cobalt (Co), nickel (Ni), zinc (Zn), tin (Sn), molybdenum (Mo), calcium (Ca), or an alloy including at least one thereof. These may be used alone or in combination of two or more thereof. For example, the antenna pattern layer 120 may include silver (Ag) or a silver alloy (e.g., a silver-palladium-copper (APC) alloy) to implement a low resistance. As another example, the antenna pattern layer 120 may include copper (Cu) or a copper alloy (e.g., a copper-calcium (CuCa) alloy) in consideration of low resistance and fine line width patterning.

According to an embodiment, the antenna pattern layer 120 may include a transparent conductive oxide such as indium tin oxide (ITO), indium zinc oxide (IZO), indium zinc tin oxide (IZTO), zinc oxide (ZnOx), or copper oxide (CuO).

According to an embodiment, the antenna pattern layer 120 may include a lamination structure of a transparent conductive oxide layer and a metal layer, for example, may have a two-layer structure of transparent conductive oxide layer-metal layer or a three-layer structure of transparent conductive oxide layer-metal layer-transparent conductive oxide. In this case, the signal transmission speed may be improved by reducing resistance while improving flexible properties by the metal layer, and corrosion resistance and transparency may be improved by the transparent conductive oxide layer.

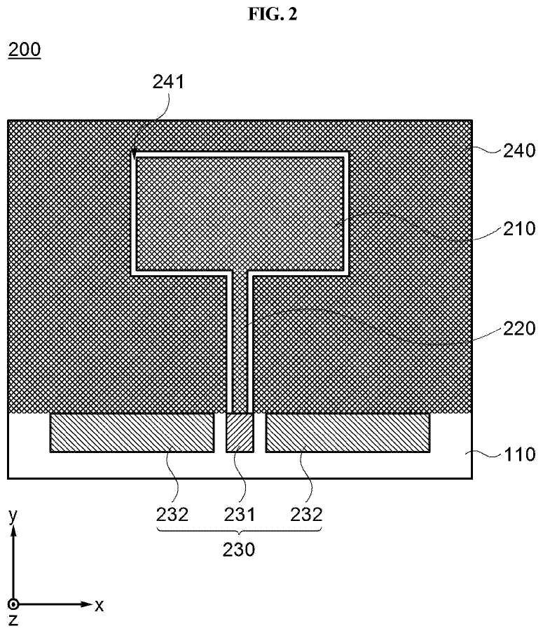

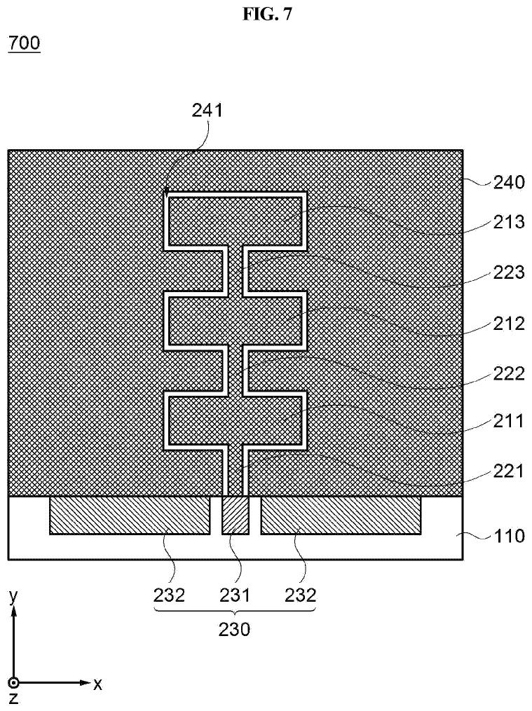

Specific details of the antenna pattern layer 120 will be described below with reference to FIGS. 2 and 7.

According to an embodiment, the antenna element 100 may further include a ground layer 130. Since the antenna element 100 includes the ground layer 130, vertical radiation characteristics may be implemented.

The ground layer 130 may be formed on a lower surface of the dielectric layer 110. The ground layer 130 may be overlapped with the antenna pattern layer 120 with the dielectric layer 110 interposed therebetween. For example, the ground layer 130 may be entirely overlapped with radiators (see 210 in FIGS. 2 and 211, 212 and 213 in FIG. 7) of the antenna pattern layer 120.

According to an embodiment, a conductive member of the display device or display panel on which the antenna element 100 is mounted may be provided as the ground layer 130. For example, the conductive member may include electrodes or wirings such as a gate electrode, source/drain electrodes, pixel electrode, common electrode, data line, scan line, etc. of a thin film transistor (TFT) included in the display panel; and a stainless steel (SUS) plate, heat radiation sheet, digitizer, electromagnetic shielding layer, pressure sensor, fingerprint sensor, etc. of the display device.

FIG. 2 is a schematic plan view illustrating an antenna element according to an exemplary embodiment. An antenna element 200 of FIG. 2 may be an example of the antenna element 100 of FIG. 1.

Referring to FIGS. 1 and 2, the antenna element 200 according to an embodiment may include the antenna pattern layer 120 formed on the upper surface of the dielectric layer 110, and the antenna pattern layer 120 may include a radiator 210, a transmission line 220 and a pad electrode 230.

The radiator 210 may be formed in a mesh structure or solid structure, or a structure in which the mesh structure and the solid structure are mixed. When the radiator 210 is formed in the mesh structure, transmittance of the radiator 210 may be increased, and flexibility of the antenna element 200 may be improved. Accordingly, the antenna element 200 may be effectively applied to a flexible display device.

A length and a width of the radiator 210 may be determined depending on a desired resonance frequency, radiation resistance, and gain. According to an embodiment, the resonant frequency may belong to a band of 24 GHz to 40 GHz, but this is only an example, and it is not limited thereto.

The radiator 210 may be electrically connected to the transmission line 220 to be fed through the transmission line 220.

According to an embodiment, as shown in FIG. 2, the radiator 210 may be implemented in a rectangular shape. However, this is only an example and there is no particular limitation on the shape of the radiator 210. For example, the radiator 210 may be formed in various planar structures such as a pentagon, hexagon, rhombus, circle, notch and the like.

The transmission line 220 may be disposed between the radiator 210 and a signal pad 231 of the pad electrode 230 and may be branched from a central portion of the radiator 210 to electrically connect the radiator 210 and the signal pad 231.

According to an embodiment, the transmission line 220 may include substantially the same conductive material as the radiator 210. Further, the transmission line 220 may be formed as a substantial single member by integrally connecting with the radiator 210, or may be formed as a separate member from the radiator 210.

According to an embodiment, the transmission line 220 may formed in a mesh structure or solid structure, or a structure in which the mesh structure and the solid structure are mixed. When forming the transmission line 220 in the mesh structure, it may be formed in a mesh structure having substantially the same shape (e.g., having the same line width, the same interval, etc.) as the radiator 210, but it is not limited thereto, and may be formed in a mesh structure having substantially different shape from the radiator 210.

The pad electrode 230 may include the signal pad 231 and ground pads 232.

The signal pad 231 may be connected to an end of the transmission line 220, thus to be electrically connected to the radiator 210 through the transmission line 220. Thereby, the signal pad 231 may electrically connect a driving circuit unit (such as a radio frequency integrated circuit (RFIC)) and the radiator 210. For example, a flexible printed circuit board (FPCB) may be bonded to the signal pad 231, and a transmission line of the FPCB may be electrically connected to the signal pad 231. For example, the signal pad 231 may be electrically connected to the FPCB using an anisotropic conductive film (ACF) bonding technique, which is a bonding method that allows electrical conduction up and down and insulates left and right using an anisotropic conductive film (ACF), or using a coaxial cable, but it is not limited thereto. The driving circuit unit may be mounted on the FPCB or a separate printed circuit board (PCB) to be electrically connected to the transmission line of the FPCB. Accordingly, the radiator 210 and the driving circuit unit may be electrically connected with each other.

The ground pads 232 may be disposed around the signal pad 231 so as to be electrically and physically separated from the signal pad 231. For example, a pair of ground pads 232 may be disposed to face each other with the signal pad 231 interposed therebetween.

According to an embodiment, the signal pad 231 and the ground pad 232 may be formed in a solid structure including the above-described metal or alloy to reduce a signal resistance. In this case, the signal pad 231 and the ground pad 232 may be formed in a multilayer structure including the above-described metal or alloy layer and the transparent conductive oxide layer.

According to an embodiment, the antenna element 200 may further include a dummy pattern 240 formed on the dielectric layer 110.

The dummy pattern 240 may be disposed around the radiator 210 and the transmission line 220.

The dummy pattern 240 is formed in a mesh structure having substantially the same shape as at least one of the radiator 210 and the transmission line 220, and may include the same metal as at least one of the radiator 210 and the transmission line 220. According to an embodiment, the dummy pattern 240 may be formed in a segmented mesh structure.

The dummy pattern 240 may be disposed so as to be electrically and physically separated from the radiator 210, the transmission line 220 and the pad electrode 230. For example, a separation region 241 may be formed along side lines of the radiator 210 and the transmission line 220 to separate the dummy pattern 240 from the radiator 210 and the transmission line 220.

As described above, by arranging the dummy pattern 240 having a mesh structure substantially the same as at least one of the radiator 210 and the transmission line 220 around the radiator 210 and the transmission line 220, optical uniformity of the patterns may be improved, and thereby it is possible to prevent the radiator 210 and the transmission line 220 from being viewed.

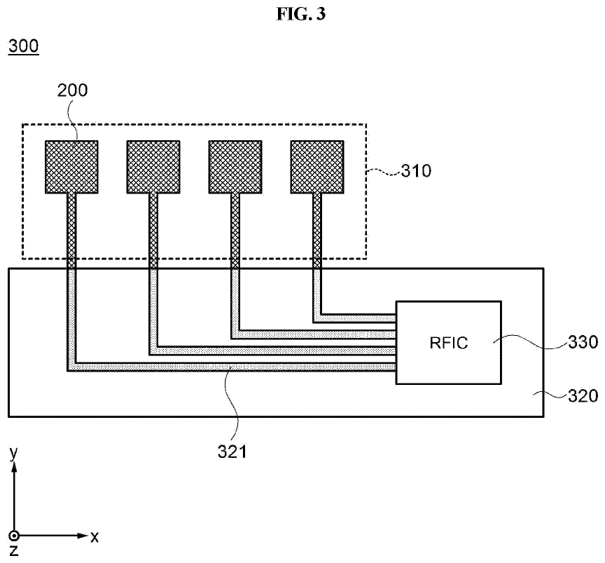

FIG. 3 is a view illustrating an antenna device according to an exemplary embodiment. Details of the contents substantially the same as those of the structures and configurations described with reference to FIGS. 1 and 2 will not be described. In addition, for the convenience of description, the pad electrode 230 of the antenna element 200 will not be illustrated in FIG. 3.

Referring to FIG. 3, an antenna device 300 may include an array antenna 310, a FPCB 320 and a RFIC 330.

The array antenna 310 may include a plurality of antenna elements 200 arranged in a predetermined direction (such as an x direction).

According to an embodiment, all the plurality of antenna elements 200 may have the same resonant frequency or may have different resonant frequencies. In addition, the plurality of antenna elements 200 may be divided into one or more groups, and the antenna elements may have different resonance frequencies for each group.

According to an embodiment, the plurality of antenna elements 200 may be linearly arranged at a predetermined interval. In this case, the predetermined interval may be determined in consideration of the resonance frequency of each antenna element 200 in order to minimize radiation interference between the antenna elements 200.

The FPCB 320 may include a plurality of transmission lines 321 which are electrically connected to each antenna element 200. As described above with reference to FIG. 2, each transmission line 321 of the FPCB 320 may be electrically connected with the signal pad 231 of each antenna element 200, thus to be electrically connected with the transmission line 220 and the radiator 210 of each antenna element 200. Thereby, an electric signal applied from the RFIC 330 may be transmitted to each antenna element 200 through each transmission line 321.

According to an embodiment, the plurality of transmission lines 321 may have different lengths (physical length and/or electrical length, hereinafter the same shall apply). For example, all the plurality of transmission lines 321 may have different lengths, or the plurality of transmission lines 321 may be divided into one or more groups, and the transmission lines may have different lengths for each group.

The FPCB 320 may include a transmission line layer including the plurality of transmission lines 321 and a ground layer for preventing radiation of the transmission line 321. According to an embodiment, the ground layer may be disposed on an upper surface of the transmission line layer, on a lower surface of the transmission line layer, or may be disposed on the upper and lower surfaces of the transmission line layer.

The RFIC 330 may be mounted on the FPCB 320, thus to be electrically connected with the plurality of transmission lines 321. To this end, the RFIC 330 may include a single port or a plurality of ports. When the RFIC 330 includes a plurality of ports, the plurality of ports may be connected to the plurality of transmission lines 321 one-to-one.

The RFIC 330 may adjust a phase of the electric signal applied to each transmission line 321 in order to compensate for a phase delay effect generated due to a difference in the lengths of each transmission line 321. For example, the RFIC 330 may adjust the phase of the electric signal applied to each transmission line 321 based on phase delay information for each transmission line, which is previously established in consideration of the lengths of each transmission line 321, etc., such that the phase delay effect due to the difference in the lengths of each transmission line 321 may be compensated. Thereby, the RFIC 330 may adjust the phase of the electric signal applied to each antenna element 200.

The RFIC 330 may adjust a magnitude of the electric signal applied to each transmission line 321 in order to compensate for a loss of each transmission line 321. For example, the RFIC 330 adjusts the magnitude of the electric signal applied to each transmission line 321 based on loss information for each transmission line, which is previously established in consideration of the lengths and arrangement shapes (such as a curved or bent shape, etc.) of each transmission line 321, such that the loss of each transmission line 321 may be compensated. Thereby, the RFIC 330 may adjust the magnitude of the electric signal applied to each antenna element 200.

As described above, according to an embodiment, the RFIC 330 adjusts at least one of the magnitude and phase of the electric signal applied to each transmission line 321, and applies the electric signal of which at least one of the magnitude and phase is adjusted to each transmission line 321, such that it is possible to compensate for the phase delay and/or loss of each transmission line 321. Accordingly, even when implementing the plurality of transmission lines 321 so as to have different lengths, the phase delay and loss of each transmission line 321 may be compensated through the RFIC 330. In addition, by implementing each transmission line 321 to have a minimum length, the loss caused by the transmission line may be reduced.

According to an embodiment, the RFIC 330 may adjust the phase of the electric signal applied to each transmission line 321, thus to control a beamforming direction of the array antenna 310. Accordingly, the RFIC 330 may adjust the phase of the electric signal applied to each transmission line 321, thus to control the phase of the electric signal applied to each antenna element 200, and thereby, it is possible to form a beam pattern in a desired direction.

Meanwhile, FIG. 3 illustrates the plurality of transmission lines 321 in a form of being bent once, but it is not limited thereto. For example, the plurality of transmission lines 321 may be arranged in a straight-line shape without bending, or may be arranged in a curved shape. Hereinafter, this arrangement form may be equally applied to the remaining drawings.

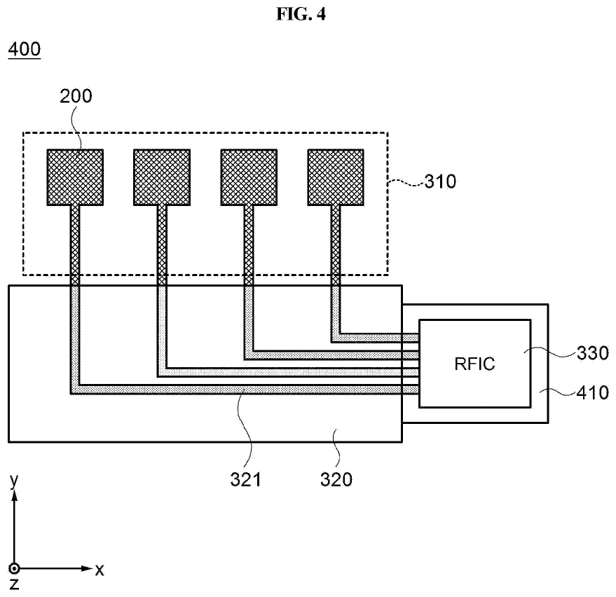

FIG. 4 is a view illustrating an antenna device according to an exemplary embodiment. Details of the contents substantially the same as those of the structures and configurations described with reference to FIGS. 1 to 3 will not be described. In addition, for the convenience of description, the pad electrode 230 of the antenna element 200 will not be illustrated in FIG. 4.

Referring to FIG. 4, an antenna device 400 may include an array antenna 310, a FPCB 320, a PCB 410 and a RFIC 330. The RFIC 330 may be mounted on the PCB 410 unlike the antenna device 300 shown in FIG. 3. The PCB 410 may be electrically connected with the FPCB 320 using an anisotropic conductive film (ACF) bonding technique, which is a bonding method that allows electrical conduction up and down and insulates left and right using an anisotropic conductive film (ACF), or using a connector (such as a coaxial cable connector, or a board connector, etc.), but it is not limited thereto.

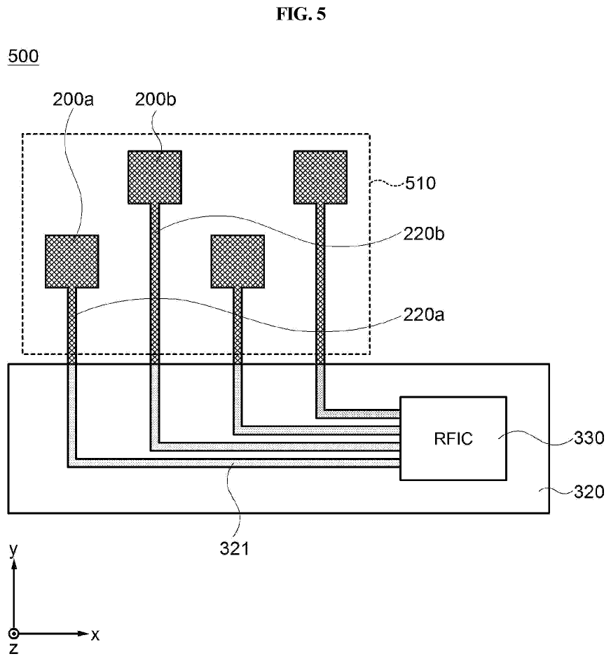

FIG. 5 is a view illustrating an antenna device according to an exemplary embodiment. Details of the contents substantially the same as those of the structures and configurations described with reference to FIGS. 1 to 4 will not be described. In addition, for the convenience of description, the pad electrodes 230 of the antenna elements 200a and 200b will not be illustrated in FIG. 5.

Referring to FIG. 5, an antenna device 500 may include an array antenna 510, a FPCB 320 and a RFIC 330.

The array antenna 510 may include a plurality of antenna elements 200a and 200b which are non-linearly arranged in a predetermined direction (such as an x direction). Herein, the antenna elements 200a and 200b may be the antenna element 200 described above with reference to FIGS. 1 and 2.

A first antenna element 200a and a second antenna element 200b are alternately arranged in a predetermined direction, and may include transmission lines 220a and 220b having different lengths. In this case, the RFIC 330 may adjust at least one of the magnitude and phase of the electric signal applied to each transmission line 321 in further consideration of the transmission lines 220a and 220b of each antenna element 200a and 200b in addition to the plurality of transmission lines 321 of the FPCB 320.

Meanwhile, the first antenna element 200a and the second antenna element 200b may have the same resonance frequency or different resonance frequencies.

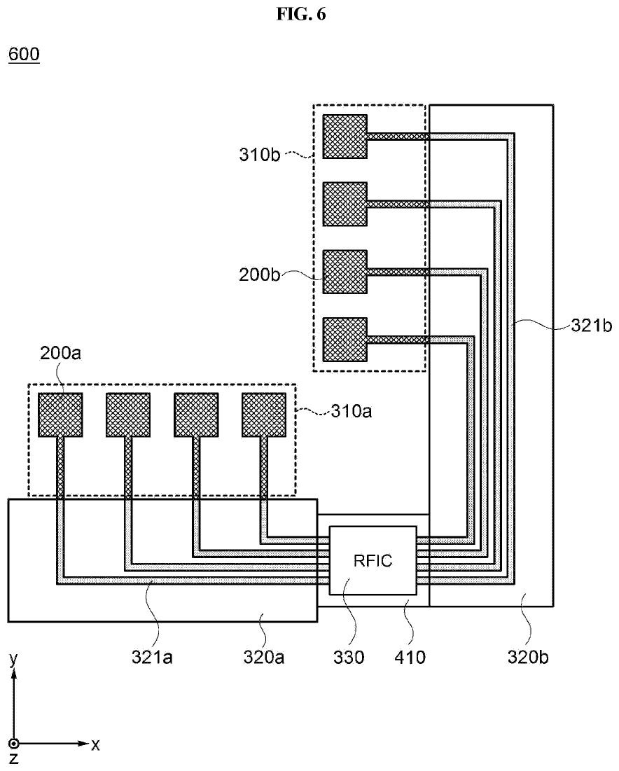

FIG. 6 is a view illustrating an antenna device according to an exemplary embodiment. Details of the contents substantially the same as those of the structures and configurations described with reference to FIGS. 1 to 5 will not be described. In addition, for the convenience of description, the pad electrode 230 of the antenna element 200 will not be illustrated in FIG. 6.

Referring to FIG. 6, an antenna device 600 may include a first array antenna 310a, a second array antenna 310b, a first FPCB 320a, a second FPCB 320b, a PCB 410 and a RFIC 330. Herein, the first array antenna 310a and the second array antenna 310b may be the array antennas 310 and 510 described above with reference to FIGS. 3 to 5, and the first FPCB 320a and the second FPCB 320b may be the FPCB 320 described above with reference to FIGS. 3 to 5.

The first array antenna 310a may include a plurality of antenna elements 200a arranged in the x direction, and the second array antenna 310b may include a plurality of antenna elements 200b arranged in they direction.

According to an embodiment, the beamforming directions of the first array antenna 310a and the second array antenna 310b may be different, so that the first array antenna 310a and the second array antenna 310b may transmit or receive different information without mutual interference. For example, the beamforming direction of the first array antenna 310a may be adjusted on a yz plane, and the beamforming direction of the second array antenna 310b may be adjusted on an xz plane, but it is not limited thereto.

According to an embodiment, resonant frequencies of the first array antenna 310a and the second array antenna 310b may be different. For example, the first array antenna 310a may have a first resonant frequency, and the second array antenna 310b may have a second resonant frequency. In this case, the first resonant frequency and the second resonant frequency may belong to a band of 24 GHz to 40 GHz. However, it is not limited thereto, and the first array antenna 310a and the second array antenna 310b may have the same resonance frequency, or all the plurality of antenna elements 200a and 200b may have different resonance frequencies regardless of the array antenna to which they belong. In addition, the plurality of antenna elements 200a and 200b may be divided into one or more groups, and the antenna elements may have different resonance frequencies for each group.

According to an embodiment, the first array antenna 310a may transmit or receive a vertically polarized wave, and the second array antenna 310b may transmit or receive a horizontally polarized wave, but it is not limited thereto.

Meanwhile, the plurality of antenna elements 200a of the first array antenna 310a and the plurality of antenna elements 200a of the second array antenna 310b may be arranged linearly or nonlinearly.

Meanwhile, for the convenience of description, the antenna device 600 of FIG. 6 is shown as it includes two array antennas 310a and 310b, but it is not limited thereto. For example, the antenna device 600 may include three or more array antennas including a plurality of antenna elements arranged in various directions.

FIG. 7 is a schematic plan view illustrating an antenna element according to an exemplary embodiment. An antenna element 700 of FIG. 7 may be a series-fed array antenna element as an example of the antenna element 100 of FIG. 1. Details of the contents substantially the same as those of the structures and configurations described with reference to FIGS. 1 to 6 will not be described.

The antenna element 700 may include an antenna pattern layer 120 formed on an upper surface of a dielectric layer 110, and the antenna pattern layer 120 may include a plurality of radiators 211, 212 and 213, a plurality of transmission lines 221, 222 and 223, and a pad electrode 230.

The plurality of radiators 211, 212 and 213 may be arranged in a predetermined direction (such as a y direction).

All the plurality of radiators 211, 212 and 213 may have the same resonance frequency, or may have different resonance frequencies. In addition, the plurality of radiators 211, 212 and 213 may be divided into one or more groups, and the radiators may have different resonance frequencies for each group. According to an embodiment, the resonance frequency may belong to a band of 24 GHz to 40 GHz band, but this is only an example and it is not limited thereto.

The plurality of radiators 211, 212 and 213 may be formed in a mesh structure or a solid structure, or a structure in which the mesh structure and the solid structure are mixed. When forming the plurality of radiators 211, 212 and 213 in a mesh structure, all the plurality of radiators 211, 212 and 213 may be formed in a mesh structure having the same shape (e.g., the same line width, and/or the same interval, etc.), or may be formed in a mesh structure having different shapes (e.g., different line widths, and/or different intervals, etc.). In addition, the plurality of radiators 211, 212 and 213 may be divided into one or more groups, and the radiators may be formed in a mesh structure having different shapes for each group.

The plurality of radiators 211, 212 and 213 may be electrically connected in series through the plurality of transmission lines 221, 222 and 223 to be fed in series.

According to an embodiment, each of the radiators 211, 212 and 213 may be implemented in a rectangular shape as shown in FIG. 7. However, this is only an example and there is no particular limitation on the shapes of the radiators 211, 212 and 213. For example, the radiators 211, 212 and 213 may be formed in various planar structures such as a pentagon, hexagon, rhombus, circle, notch and the like.

The transmission line 221 may be branched from the radiator 211 to be connected to the signal pad 231, the transmission line 222 may be branched from the radiator 212 to be connected to the radiator 211, and the transmission line 223 may be branched from the radiator 213 to be connected to the radiator 212. Thereby, the plurality of radiators 211, 212 and 213 may be electrically connected in series, and electric signals applied from an outside through the plurality of transmission lines 221, 222 and 223 may be transmitted to each of the radiators 211, 212 and 213.

According to an embodiment, the plurality of transmission lines 221, 222 and 223 may include substantially the same conductive material as the plurality of radiators 211, 212 and 213. In addition, the plurality of transmission lines 221, 222 and 223 may be integrally connected with the plurality of radiators 211, 212 and 213 to be formed as a substantially single member, or may be formed as a separate member from the plurality of radiators 211, 212 and 213.

According to an embodiment, the plurality of transmission lines 221, 222 and 223 may be formed in a mesh structure or a solid structure, or a structure in which the mesh structure and the solid structure are mixed. When forming the plurality of transmission lines 221, 222 and 223 in a mesh structure, the plurality of transmission lines 221, 222 and 223 may be formed in a mesh structure having the same shape (e.g., the same line width, and/or the same interval, etc.) as at least one of the plurality of radiators 211, 212 and 213.

According to an embodiment, the antenna element 700 may further include a dummy pattern 240 formed on the dielectric layer 110. The dummy pattern 240 may be disposed around the plurality of radiators 211, 212 and 213, and the plurality of transmission lines 221, 222 and 223.

The dummy pattern 240 may be formed in a mesh structure having substantially the same shape as at least one of the plurality of radiators 211, 212 and 213, and the plurality of transmission lines 221, 222 and 223, and may include the same metal as at least one of the plurality of radiators 211, 212 and 213, and the plurality of transmission lines 221, 222 and 223.

The dummy pattern 240 may be arranged so as to be electrically and physically separated from the plurality of radiators 211, 212 and 213, the plurality of transmission lines 221, 222 and 223, and the pad electrode 230. For example, the separation region 241 may be formed along side lines of the plurality of radiators 211, 212 and 213, and the plurality of transmission lines 221, 222 and 223, thus to separate the dummy pattern 240 from the plurality of radiators 211, 212 and 213, and the plurality of transmission lines 221, 222 and 223.

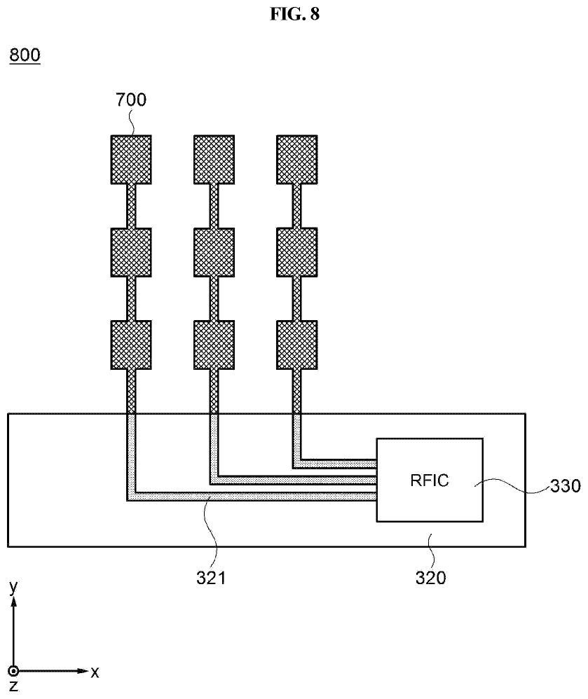

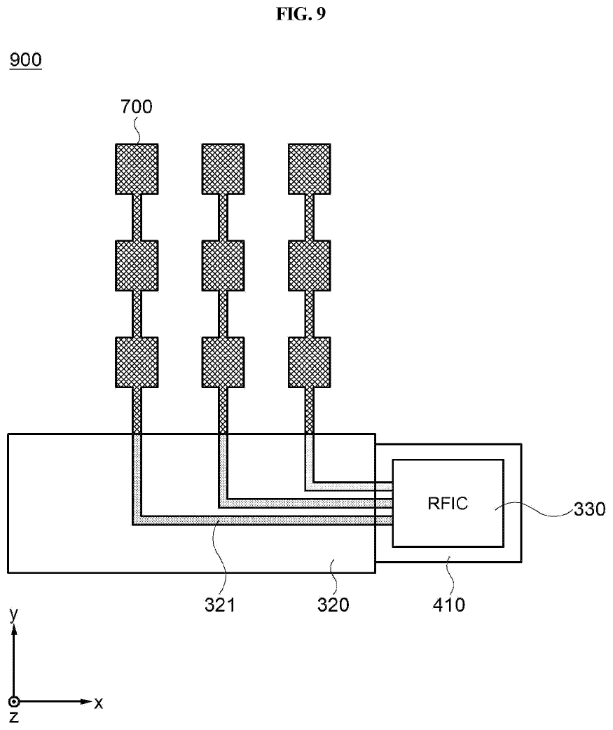

FIGS. 8 and 9 are views illustrating antenna devices according to exemplary embodiments. Details of the contents substantially the same as those of the structures and configurations described with reference to FIGS. 1 to 7 will not be described. In addition, for the convenience of description, the pad electrodes 230 of antenna elements 700 will not be illustrated in FIGS. 8 and 9.

Referring to FIGS. 8 and 9, antenna devices 800 and 900 may include a plurality of antenna elements 700 arranged in a predetermined direction (such as an x direction). In this case, the antenna element 700 may be a series-fed array antenna element.

According to an embodiment, all the plurality of antenna elements 700 may have the same resonant frequency or may have different resonant frequencies. In addition, the plurality of antenna elements 700 may be divided into one or more groups, and the antenna elements may have different resonance frequencies for each group.

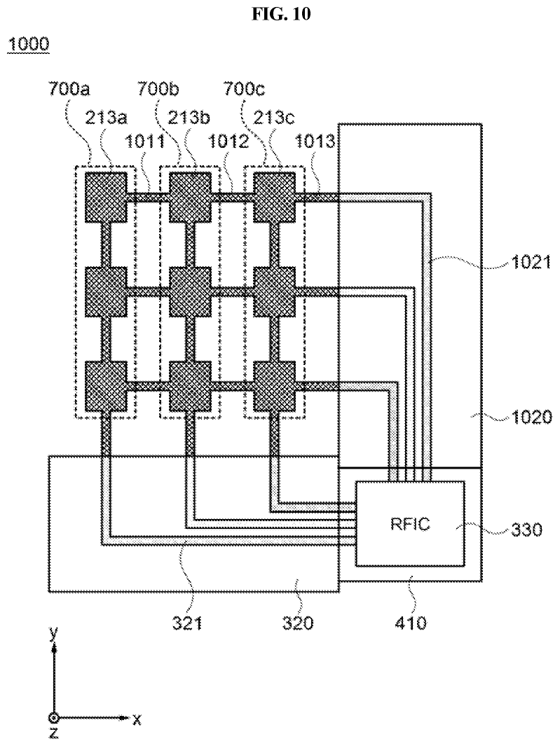

FIG. 10 is a view illustrating an antenna device according to an exemplary embodiment. Details of the contents substantially the same as those of the structures and configurations described with reference to FIGS. 1 to 9 will not be described. In addition, for the convenience of description, the pad electrodes 230 of antenna elements 700a, 700b and 700c will not be illustrated in FIG. 10.

Referring to FIG. 10, the antenna device 1000 may include a plurality of antenna elements 700a, 700b and 700c, a plurality of transmission lines 1011, 1012 and 1013, a first FPCB 320, a second FPCB 1020, a PCB 410 and a RFIC 330. Herein, the plurality of antenna elements 700a, 700b and 700c may be the antenna element 700 described above with reference to FIG. 7.

The plurality of transmission lines 1011, 1012 and 1013 may connect the radiators 213a, 213b and 213c of the plurality of antenna elements 700a, 700b and 700c in an arrangement direction (such as an x direction) of the plurality of antenna elements 700a, 700b and 700c in series. For example, the transmission line 1011 may be branched from the radiator 213a of the antenna element 700a to be connected to the radiator 213b of the antenna element 700b, and the transmission line 1012 may be branched from the radiator 213b of the antenna element 700b to be connected to the radiator 213c of the antenna element 700c. In addition, the transmission line 1013 may be branched from the radiator 213c of the antenna element 700c to extend in the arrangement direction (such as the x direction) of the antenna elements 700a, 700b and 700c, and may be electrically connected with the transmission line 1021 of the second FPCB 1020. Thereby, the radiators 213a, 213b and 213c of the plurality of antenna elements 700a, 700b and 700c may be cross-connected in two dimensions to form an m×n matrix structure. Herein, m and n may be determined depending on the number of antenna elements arranged in the x direction and the number of radiators of the antenna elements arranged in they direction.

The radiators 213a, 213b and 213c of adjacent antenna elements may be electrically connected in series through the plurality of transmission lines 1011, 1012 and 1013, and electric signals applied from the outside may be transmitted to each of the radiators 213a, 213b and 213c. For example, the plurality of radiators 213a, 213b and 213c may be electrically connected in series through the plurality of transmission lines 1011, 1012 and 1013 to be fed in series.

According to an embodiment, beamforming directions of an x-direction arrangement of the radiators and a y-direction arrangement of the radiators may be different, so that the x-direction arrangement of the radiators and the y-direction arrangement of the radiators may transmit or receive different information without mutual interference. For example, the beamforming direction of the x-direction arrangement of the radiators may be adjusted on the yz plane, and the beamforming direction of the y-direction arrangement of the radiators may be adjusted on the xz plane, but it is not limited thereto.

According to an embodiment, the plurality of transmission lines 1011, 1012 and 1013 may include substantially the same conductive material as the plurality of radiators 213a, 213b and 213c. In addition, the plurality of transmission lines 1011, 1012 and 1013 may be integrally connected with the plurality of radiators 213a, 213b and 213c to form a substantially single member, or may be formed as a separate member from the plurality of radiators 213a, 213b and 213c.

According to an embodiment, the plurality of transmission lines 1011, 1012 and 1013 may be formed in a mesh structure or a solid structure, or a structure in which the mesh structure and the solid structure are mixed. When forming the plurality of transmission lines 1011, 1012 and 1013 in a mesh structure, the plurality of transmission lines 1011, 1012 and 1013 may be formed in a mesh structure having the same shape (e.g., the same line width, and/or the same interval, etc.) as at least one of the plurality of radiators 213a, 213b and 213c.

The second FPCB 1020 may include a plurality of transmission lines 1021 which are electrically connected to radiators 213a, 213b and 213c forming each row of the m×n matrix structure. According to an embodiment, similar to the case described above with reference to FIG. 7, each transmission line 1021 of the second FPCB 1020 may be electrically connected with the signal pads connected to the transmission line 1013 of each row in the m×n matrix structure, thus to be electrically connected with the radiators 213a, 213b and 213c forming each row. Thereby, the electrical signal applied from the RFIC 330 may be transmitted to the radiators 213a, 213b and 213c forming each row in the m×n matrix structure through each transmission line 1021.

According to an embodiment, the plurality of transmission lines 1021 may have different lengths. For example, all the plurality of transmission lines 1021 may have different lengths, or the plurality of transmission lines 1021 may be divided into one or more groups, and the transmission lines may have different lengths for each group.

The second FPCB 1020 may include a transmission line layer including the plurality of transmission lines 1021 and a ground layer for preventing radiation of the transmission line 1021. According to an embodiment, the ground layer may be disposed on an upper surface of the transmission line layer, on a lower surface of the transmission line layer, or may be disposed on the upper and lower surfaces of the transmission line layer.

The RFIC 330 may be mounted on the PCB 410, thus to be electrically connected with the plurality of transmission lines 321 and 1021.

The RFIC 330 may adjust a phase of an electric signal applied to each of the transmission lines 321 and 1021 in order to compensate for a phase delay effect generated due to a difference in electrical lengths of each of the transmission lines 321 and 1021. Further, the RFIC 330 may adjust a magnitude of the electric signal applied to each of the transmission lines 321 and 1021 in order to compensate for a loss of each of the transmission lines 321 and 1021.

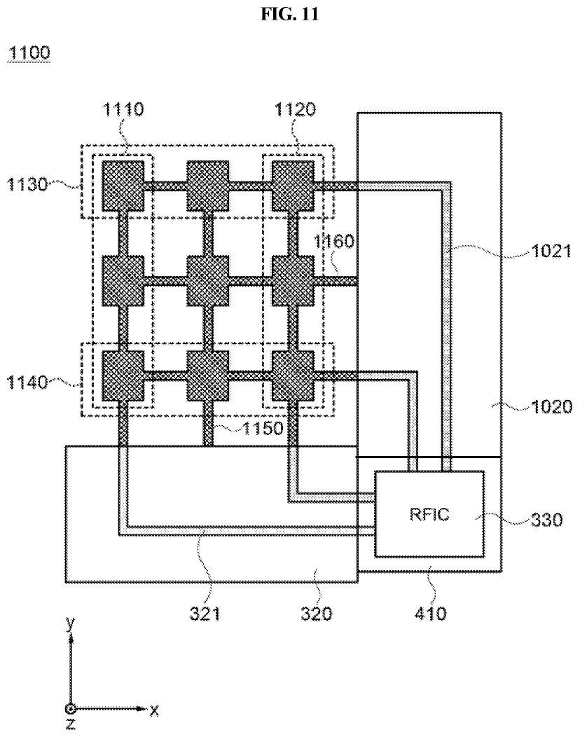

FIG. 11 is a view illustrating an antenna device according to an exemplary embodiment. Details of the contents substantially the same as those of the structures and configurations described with reference to FIGS. 1 to 10 will not be described.

Referring to FIG. 11, unlike the antenna device 1000 of FIG. 10, in an antenna device 1100, the number of transmission lines 321 of the first FPCB 320 may be different from the number of columns in an m×n matrix formed by the radiators, and the number of transmission lines 1021 of the second FPCB 1020 may be different from the number of rows in the m×n matrix formed by the radiators. For example, the transmission line 1021 may be connected only to the radiation electrodes of some rows 1130 and 1140, and the transmission line 321 may be connected only to the radiation electrodes of some columns 1110 and 1120.

Due to the above-described structure of the antenna device 1100, an internal structure of the RFIC 330 may be simplified and energy efficiency may be increased.

Meanwhile, FIG. 11 illustrates an example of including transmission lines 1150 and 1160 as they are, which are not connected to the first FPCB 320 and the second FPCB 1020, but these lines may be omitted.

Meanwhile, in order to distinguish each transmission line, it is possible to refer to the transmission lines 321, 321a and 321b as a first transmission line, the transmission lines 220, 220a, 220b, 221, 222 and 223 as a second transmission line, the transmission lines 1011, 1012 and 1013 as a third transmission line, and the transmission line 1021 as a fourth transmission line.

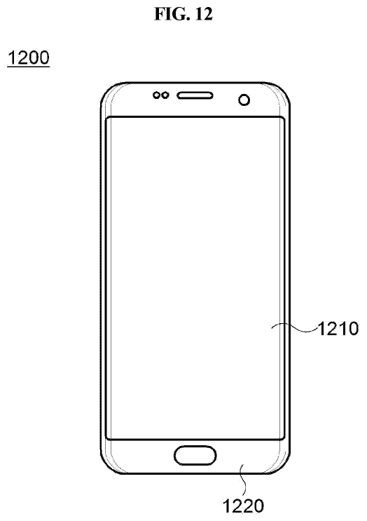

FIG. 12 is a schematic plan view for describing a display device according to an exemplary embodiment. More specifically, FIG. 12 is a view illustrating an external shape including a window of the display device.

Referring to FIG. 12, a display device 1200 may include a display region 1210 and a peripheral region 1220.

The display region 1210 may indicate a region in which visual information is displayed, and the peripheral region 1220 may indicate an opaque region disposed on both sides and/or both ends of the display region 1210. For example, the peripheral region 1220 may correspond to a light-shielding part or a bezel part of the display device 1200.

According to an embodiment, the above-described antenna elements 100, 200 and 700, or antenna devices 300, 400, 500, 600, 800, 900, 1000 and 1100 may be mounted on the display device 1200. For example, the radiators 210, 211, 212 and 213, and the transmission lines 220, 221, 222 and 223 of the antenna elements 200 and 700 may be disposed so as to at least partially correspond to the display region 1210 of the display device 1200, and the pad electrode 230 may be disposed so as to correspond to the peripheral region 1220 of the display device 1200. In addition, the array antennas 310, 310a, 310b and 510 of the antenna devices 300, 400, 500, 600, 800, 900, 1000 and 1100, and the antenna elements 700, 700a, 700b and 700c may be disposed so as to at least partially correspond to the display region 1210 of the display device 1200, and the FPCBs 320, 320a, 320b and 1020 and/or the PCB 410 may be disposed so as to at least partially correspond to the peripheral region 1220 of the display device 1200.

By arranging the pad electrodes 230 of the antenna elements 100, 200, and 700 so as to be adjacent to the RFIC 330, signal loss may be suppressed by shortening a path for transmitting and receiving signals.

When the antenna elements 100, 200, and 700 include the dummy pattern 240, the dummy pattern 240 may be disposed so as to at least partially correspond to the display region 1210 of the display device 1200.

The antenna elements 100, 200 and 700 include the radiators 210, 211, 212 and 213, the transmission lines 220, 221, 222 and 223 and/or the dummy pattern 240, which are formed in the mesh structure, such that it is possible to significantly reduce or suppress the patterns from being viewed while improving the transmittance. Accordingly, image quality in the display region 1210 may also be improved while maintaining or improving desired communication reliability.

The present invention has been described with reference to the preferred embodiments above, and it will be understood by those skilled in the art that various modifications may be made within the scope without departing from essential characteristics of the present invention. Accordingly, it should be interpreted that the scope of the present invention is not limited to the above-described embodiments, and other various embodiments within the scope equivalent to those described in the claims are included within the present invention.

What is claimed is:

1. An antenna device comprising:
an array antenna including a plurality of antenna elements;
a first flexible printed circuit board (FPCB) including a plurality of first transmission lines which are electrically connected to the plurality of antenna elements and have different lengths; and
a radio frequency integrated circuit (RFIC) electrically connected to the plurality of first transmission lines.

2. The antenna device according to claim 1, wherein the RFIC is configured to adjust at least one of a phase and a magnitude of an electric signal applied to each first transmission line in order to compensate for at least one of a phase delay and a loss generated in each first transmission line.

3. The antenna device according to claim 1, wherein the RFIC is mounted on the first FPCB.

4. The antenna device according to claim 1, further comprising a printed circuit board (PCB) electrically connected to the first FPCB,
wherein the RFIC is mounted on the PCB.

5. The antenna device according to claim 1, wherein each of the plurality of antenna elements comprises:
a dielectric layer;
a radiator disposed on an upper surface of the dielectric layer; and
a second transmission line connected to the radiator on the upper surface of the dielectric layer.

6. The antenna device according to claim 5, wherein the array antenna comprises:
a first array antenna including a plurality of first antenna elements arranged in a first direction; and
a second array antenna including a plurality of second antenna elements arranged in a second direction.

7. The antenna device according to claim 6, wherein a beamforming direction of the first array antenna is adjusted on a yz plane, and a beamforming direction of the second array antenna is adjusted on an xz plane.

8. The antenna device according to claim 6, wherein the first direction and the second direction are perpendicular to each other.

9. The antenna device according to claim 5, wherein second transmission lines of at least some of the plurality of antenna elements have different lengths. 10. The antenna device according to claim 5, wherein the radiator and the second transmission line are formed in a mesh structure, respectively.

11. The antenna device according to claim 5, wherein each of the plurality of antenna elements further comprises a ground layer disposed on a lower surface of the dielectric layer.

12. The antenna device according to claim 5, wherein each of the plurality of antenna elements further comprises a dummy pattern disposed around the radiator and the second transmission line on the upper surface of the dielectric layer.

13. The antenna device according to claim 1, wherein each of the plurality of antenna elements is a series-fed array antenna element.

14. The antenna device according to claim 13, wherein each of the plurality of antenna elements comprises:
a dielectric layer;
a plurality of radiators arranged on an upper surface of the dielectric layer; and
a plurality of second transmission lines configured to connect the plurality of radiators in series on the upper surface of the dielectric layer.

15. The antenna device according to claim 13, wherein the plurality of antenna elements are arranged in a first direction, and the radiators are arranged in a second direction.

16. The antenna device according to claim 15, wherein the first direction and the second direction are perpendicular to each other.

17. The antenna device according to claim 15, further comprising: a plurality of third transmission lines configured to cross-connect the plurality of radiators of the plurality of antenna elements in two dimensions to form a matrix structure.

18. The antenna device according to claim 17, wherein a beamforming direction of a first direction arrangement of the plurality of radiators is adjusted on a yz plane, and a beamforming direction of a second direction arrangement of the plurality of radiators is adjusted on an xz plane.

19. The antenna device according to claim 17, further comprising a second FPCB which is electrically connected with at least some of the plurality of third transmission lines and includes a plurality of fourth transmission lines having different lengths.

20. The antenna device according to claim 19, wherein the RFIC is configured to adjust at least one of a phase and a magnitude of an electric signal applied to each fourth transmission line in order to compensate for at least one of a phase delay and a loss generated in each fourth transmission line.

21. A display device comprising the antenna device according to claim 1.
